(19) United States
(12) Patent Application Publication
(10) Pub. No.: US 2015/0220246 A1
(43) Pub. Date: Aug. 6, 2015

(54) Method and System for Managing, Evaluation and Treatment of Physical Structures for Pest Control

(71) Applicant: Rollins, Inc., Atlanta, GA (US)

(72) Inventors: Cam Glover, Decatur, GA (US); James Kynerd Coleman, Vestavia Hills, AL (US); Steve Marriott, Birmingham, AL (US); Michael Lasky, Atlanta, GA (US)

(21) Appl. No.: 14/613,857

(22) Filed: Feb. 4, 2015

Related U.S. Application Data
(60) Provisional application No. 61/936,041, filed on Feb. 5, 2014.

(51) Int. Cl. G06F 3/0481; G06F 3/0485; G06F 3/0484

(52) U.S. Cl. CPC G06F 3/04817; G06F 3/04842; G06F 3/04855

(57) ABSTRACT

A software based method and hardware system for managing, evaluation and treatment of physical structures for pest control is disclosed having a grid/graph paper display pane, icons positionable thereon, and link to a data base and a report writer which maintains a tally of icons by type and calculates pricing in the report. The report and grid may be synchronized so that changes in either are reflected in the other. The system and method also disclosed a briefcase system for tagging images from disparate program run on a portion of the display screen and concatenating tagged images into a file for later export.

### INCORPORATION BY REFERENCE

This application explicitly incorporates the entire contents of the U.S. provisional application Ser. No. 61/936,041 filed 5 Feb. 2014, titled as Method and System for Managing, Evaluation and Treatment of Physical Structures for Pest Control.

### BACKGROUND

1. Field of the Disclosure

The present disclosure relates to methods and systems for managing, evaluation, treatment and reporting of pest control for a physical structure.

2. Description of the Related Art

Heretofore, the process of evaluation, management, treatment and reporting of pest control management of physical structures (typically homes, offices, retail and manufacturing facilities) has been a manual process. An inspector/evaluator, would arrive on site, survey the property, draw a sketch of the outer boundaries thereof, roughly indicate the location of pest problems, building deficiencies and high risk areas and locations of pest defenses if any. Photos may be taken of these elements, and then the whole lot of information could be shown to the property owner as a mass of unorganized, relatively inaccurate data.

Then the pest control representative might discuss the pest risk areas by pointing to the sketch and locating the appropriate photo. In the next step, a report would be manually assembled and an action plan would be priced and brought back to the property owner. If changes in the report/plan were proposed, the report and pricing would have to be recalculated and new drawings of defenses/risks would have to be drawn up.

### BRIEF SUMMARY

To assist the reader in preparing to digest the detailed description and claims below, a short summary has been provided. It is far from complete and only provides a glimpse of the invention concepts. It is not intended to define the scope of the invention. The claims perform that function.

The present disclosures a system and method, such as by a graphical user interface computer program, for building a portfolio of user selected image screens and creating a data file output of images, running on a computer having memory, a microprocessor, data storage and display. It may have any or all of the following:
a display pane operable to display a visible set of data records, the visible set of data records including data records from a selected set of data records from a data store; a first portion of the display configured to display sequential screens of a running program;
a collection icon appearing in the display pane, said icon linked to the running program for tagging screen images appearing thereon:
a first brief case depository region on the display pane, the region configured to receive thumbnail images of screens tagged by the user when said collection icon is activated, thereby copying a thumbnail screen image of an image appearing in the first portion of the display screen and pasting said thumbnail image sequentially into said depository region;
a software routine for retrieving each of the tagged images, then retrieving the corresponding full image to which the thumbnail pertains and in concatenating the full images into a data file corresponding to a sequence of selected images and creating a computer file of such selected images for later viewing.

Also disclosed is an interface further includes a scroll bar of images appearing display pane said scroll bar displaying a plurality of icons corresponding to available programs, whereby the user can select a program from said scroll bar, tag images from said program, select an alternate program, tag images from said alternate program and build a data file of images from multiple program.

Also disclosed is an interface further includes a tile/scroll bar is located between said first display portion and said depository region.

Also disclosed is a method of building a user selected data file of user selected images from a plurality of data programs, including any or all of the following steps in any order:
a. providing a display pane connected to a computer having memory, processor and data storage;
b. accessing a display icon from each of a plurality of programs and displaying said display icons sequentially across a portion of said display pane;
c. configuring said icons to initiate their corresponding program on a portion of said display pane when user actuated thereby posting a currently displayed image on said pane;
d. providing a collection icon on a portion of the display pane,
e. configuring said collecting icon to grab the currently displayed image when said collecting icon is actuated and storing said image in a data file;
f. displaying a thumbnail representation of each of said grabbed currently displayed images sequentially in a portion of said display pane;
g. in response to user actuation, concatenating said grabbed images into a data file;
h. in response to user actuation, deleting any selected grabbed image from the data file;
i. in response to user actuation, rearranging the selected grabbed images into a user desired;
j. generating a final data file of selected grabbed images.
   This will allow the user to select individual images from a plurality of programs, arrange the images in a desired order and creating a presentation data file of said images.

Also disclosed is a method further including reserving said portion of said display pane for displaying an image of a running program, and displaying said display icons in a first scroll bar located below said reserved portion, and displaying said grabbed images in a second scroll bar under said first scroll bar.

Also disclosed is a graphical user interface computer program for assessing a physical structure for insect and pest control of the structure and generating a report therefor, having any or all of the following elements:
a display screen pane, connected to a computer processor, memory and data storage;
a graphical interface including a portion of the display pane having a grid/graph paper/wallpaper background;
a graphical interface including drawing tools for drawing physical structure representations on said grid;
a portion of said pane including a bar including a plurality of icons, said icons being linked to a data base and being positionable on the region of the pane having said grid;
a register for tallying the number of at least some icons which have been positioned on said grid;
a report generator for preparing a displayable report, said report generator being linked to said data base of tallied icons and in including at least some of said tallies into said report;
so that when a representation of a physical structure has been drawn on the grid/virtual graph paper, and populated with icons, a report is generated with a tally of icons included in the report.

Also disclosed is an interface further including a bi-directional link between said report writer and said grid, so that increasing the tally of icons on the report, generates an increase in the number of icons on the grid.

Also disclosed is an interface further includes a bi-directional link between said report writer and said grid, so that decreasing the tally of icons on the report, generates an indicia in the icons on the grid, so that the user can identify which icons must be deleted for conform to the tally in the report.

Also disclosed is an interface further includes a bi-directional link between said report writer and said grid, so that decreasing the tally of icons on the report, generates a flashing indicia in the icons on the grid, so that the user can identify which icons must be deleted for conform to the tally in the report.

Also disclosed is an interface further includes a bi-directional link between said report writer and said grid, so that decreasing the tally of icons on the report, generates an indicia in the icons on the grid, in a specific location on the grids, so that the user can identify where such additional icons must be located on the grid to conform to the tally in the report.

Also disclosed is a graphical user interface using a display pane connected to a computer processor, memory and data storage, for creating a representation of a physical structure for assessment of pest and insect control and for generating a report interactively therefrom, comprising any or all of the following steps in any order:
applying a grid wallpaper background on a portion of the display pane, the grid providing attachment points for drawing of a representative structure thereon;
locating a plurality of drawing tools for drawing a representative physical structure representation on said grid by drag and dropping elements thereof;
locating a plurality of pest control icon icons representing pest control elements on a portion of the display pane, and fixable on said pane by drag and drop to user designated locations on the grid;
linking the number of said pest control elements placed on the grid to a data base, usable for generating reports;
locating a photo icon on a portion on the display pane, said photo icon being fixable on the said grid by dragging and dropping to user designated locations thereon;
linking any photo icons dropped adjacent said structure with at least one photo stored in a photo data base, so that clicking on such icon will display such linked photo;
storing in a data base, a numerical value corresponding to price, for at least some of said pest control element icons and linking said price to said element;
generating a report at least in part calculating pricing based on the pricing data from said data base multiplied by the number of said pest control element which were placed on the grid thereby calculating a cost based on the icons based on the grid.

Also disclosed is a method further displaying a pointer on said photo icon, so that when a representation of a physical structure has been drawn on the grid, and populated with icons, a report is generated with a tally of icons included in the report.

Also disclosed is a method using a computer processor, memory, storage and a display pane, of building a brief case of images from a plurality of separate programs displayed sequentially on a graphical user interface, the method comprising any or all of the following steps in any order:
providing a display pane operable to display a plurality of programs from which a user may select;
on user entry, querying a data database to run a program to display a sequence of images on a portion of said display pane for that running program;
on user actuation of an onscreen selector element, tagging images selected from that running program and displaying an icon corresponding to each tagged image in a portion of the display pane,
on user entry, running a further program on said portion of said display pane;
on user actuation of an onscreen selector element, tagging images selected from that further running program and displaying an icon corresponding to each tagged image in a portion of the display pane,
linking said tagged icons to their corresponding images;
generating at concatenation, such as creating a file with the sequence of tagged images into a single file with the images remaining separately displayable, of all tagged images into in a single report file.

Also disclosed is a handheld computing device having any or all of the following elements:
a display screen;
an input device for operating the computing device and entering user responses;
a processor for executing programming that provides a user interface to a graphing software application wherein the user interface further comprises:
a display area on the display screen;
a graph paper area inside the display area,
an input from an input device which allows the user to manually enter data points on the graph paper area, and
wherein the manually entered data points are linked to a report, so that if data points tallied on the report are user altered, data points on the graph paper are likewise altered in quantity to maintain data synchronization between the graph paper and report.

### BRIEF DESCRIPTION OF THE SEVERAL VIEWS OF THE DRAWINGS

FIG. 1 is a flow diagram of one embodiment for computer configuration.

FIG. 2 is a block diagram of one embodiment for compute configuration.

FIG. 3 is a representative display screen illustrating a floor plan.

FIG. 4 is a representative list of icons useable on the floor plan.

FIG. 5 is a partial screen view of a display screen showing scroll bars, briefcase and bookmark tools.

### DETAILED DESCRIPTION OF THE DISCLOSURE

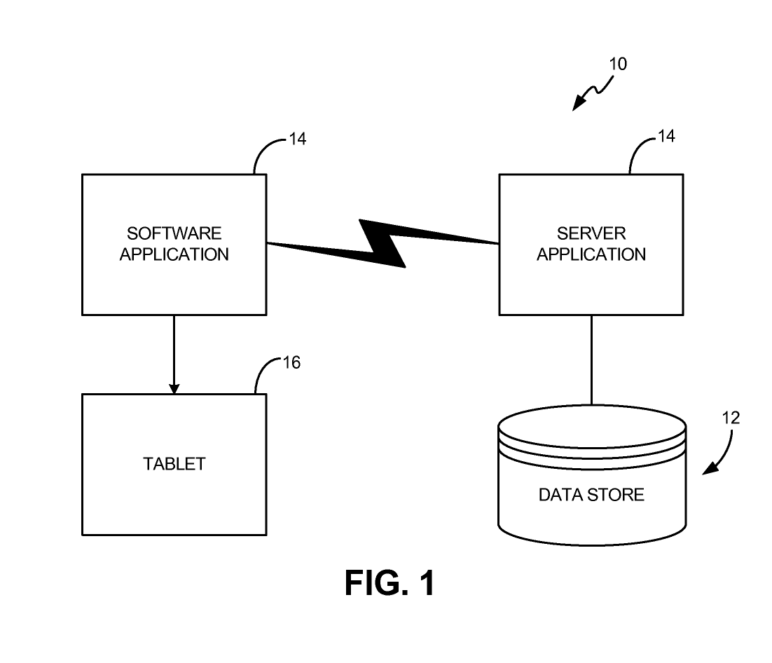

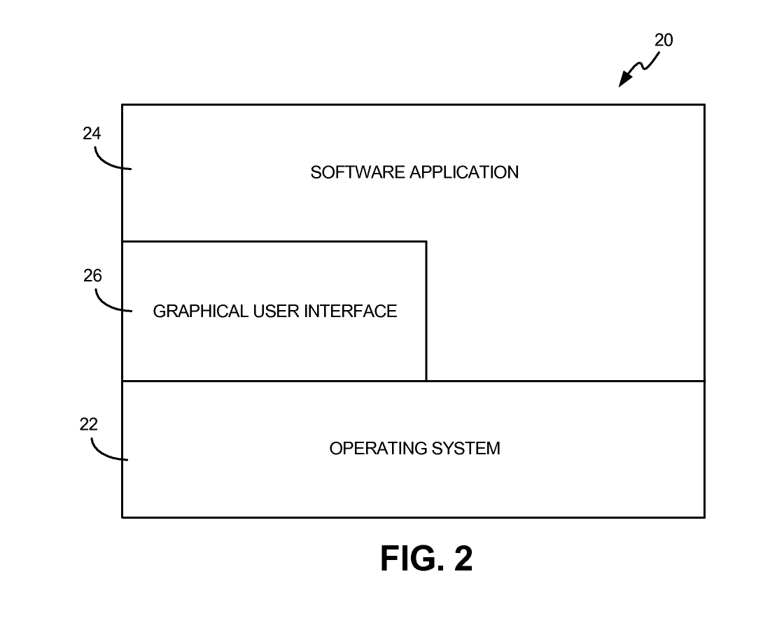

Referring to FIG. 1, a possible system 10 to carry out this disclosure may include a system a data store/database 12 is linked to a server 14 when in then linked to computer device 20 (FIG. 2) by wire/wireless connections. The link provides data to the software application 16 which has a display element/pane, such as a tablet computer 16.

FIG. 2 shows a computing device 20 having memory (transitory and/or non-transitory), an operating system 22, a software application 24 running under the operating system and a graphical user interface (GUI) 26 driving a display screen.

A graphical user interface (GUI) module 26 provides a library of routines used to implement a GUI. A GUI module 26 also may be provided as part of operating system 22. For example, Microsoft Windows is sold as an operating system; however, it includes an operating system and a module. The software environment may include various libraries or extension modules that may be used by a software application 14/24. In this example, the GUI module 26 uses the underlying operating system to provide a graphical interface for software application. Software application also may use the operating system, the GUI module, and extensions provided by an extension module. For example, the extension module may provide a scroll bar widget supporting simulated scrolling to allow the software application provide list GUI elements with simulated scrolling as will be explained below.

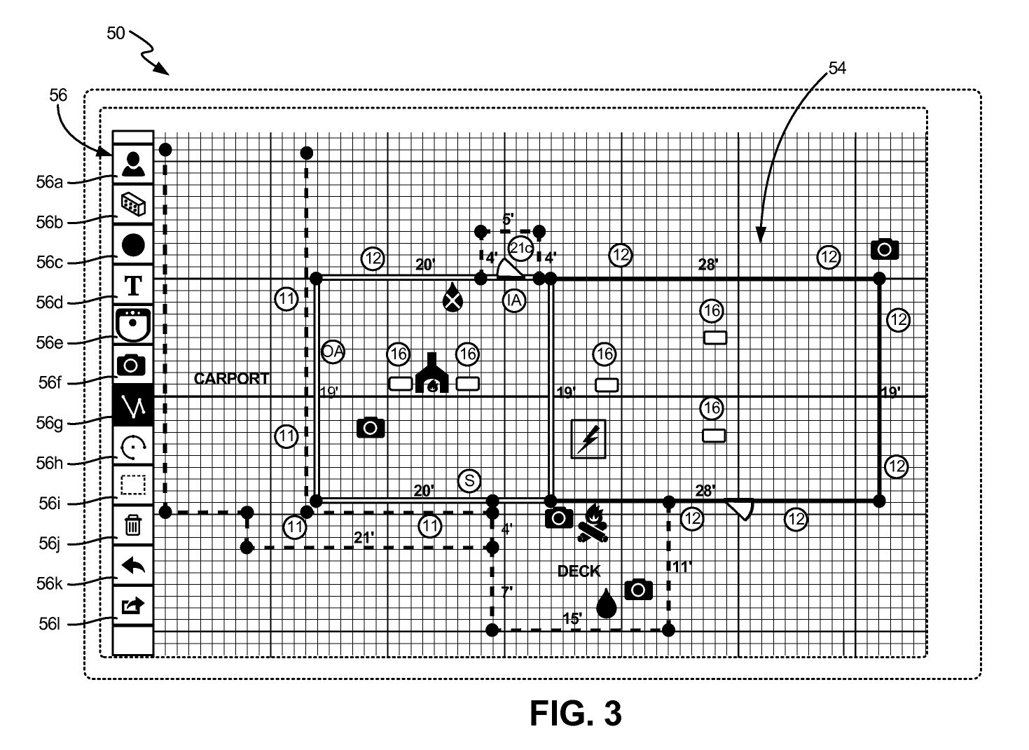

The typical display pane is a touch screen tablet, but be any display screen device. When a pest control evaluator arrives at a physical structure (building), an early step is to create a floor plan/blue print map of the structure. This may be done by the drawing tool 50 shown in FIG. 3. An alternative at is the user may download an existing floor plan data file, typically in a non-vector format like JPG, and overlay the file on the display pane. The program can optionally convert the jpg file into a vector file where each line is movable, but that is not required to achieve utility.

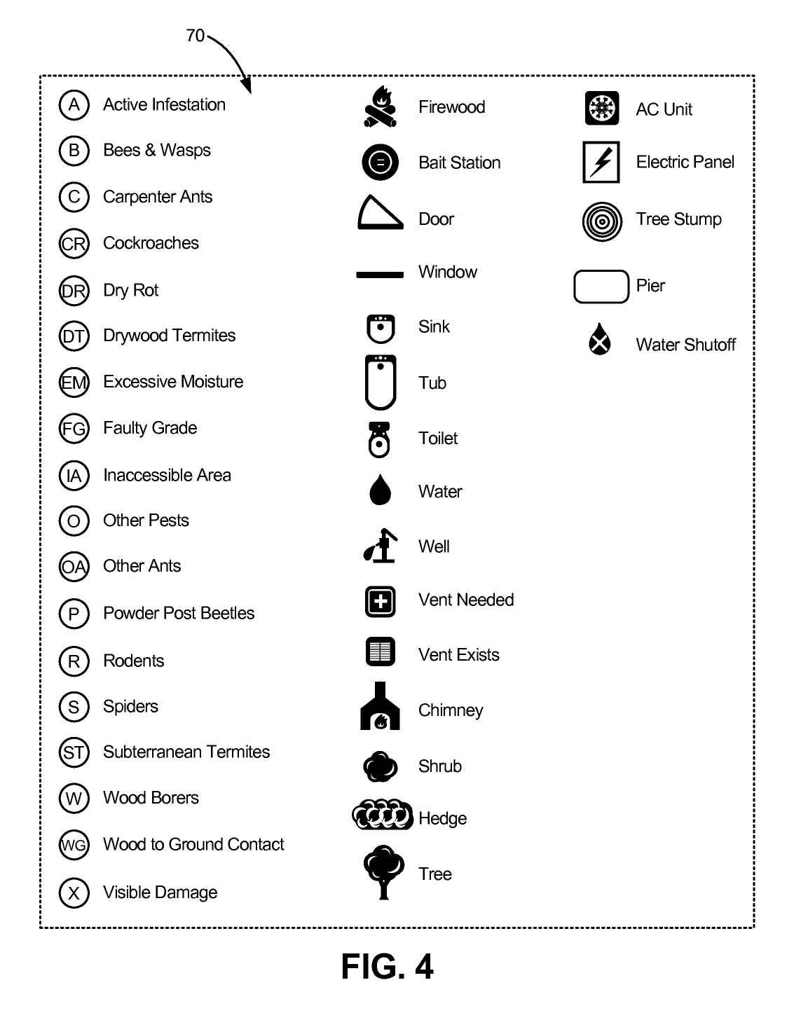

Alternatively, the user can draw the floor plan 54 by using tools from the tool bar 56 shown on the side of the screen. Each icon shown provides for a different function, which are exemplary, and may vary. The icons shown are: 56a for inputting customer information input to a linked database which produces a report output; 56b materials and dimensions input to a linked database which produces a report output; 56c are numerical/alphabetical tags which may be placed/dropped on the floor plan and which correspond to a look up data table corresponding to observed pest issues or pest treatment specification which may be recommended/ordered by the evaluator. The numbers in circles show in on the floor plan indicate treatment observations and the circled letter indicate treatments have been specified/recommended; 56d with the letter “T” places text wherever it is placed on the grid; 56e brings up a pop up screen of further icons, 70 such as shown in FIG. 4; 56f is a camera icon which links an image from a database to of images. The icon may include an arrow or pointer off one edge to indicate the direction the camera is shooting, which can be uncertain when there are corners , ceilings etc. Icon 56g provides drawing tools to draw lines on the grid. In the preferred embodiment the tools will “snap to” the grid lines. Icon 56h provides for circular shapes or parts thereof, to be drawn. Icon 56i is a cut/clip tool which combined with icon 56i, delete tool, can remove anything surrounded. Icon 56j is a undo last action tool and icon 56k is an export to report tool which brings up a report form which incorporates data from the grid and can be exported as a file or email, as will be further explained. With any icon, when hovering over with a pointer/mouse, a data box may appear such as to show an image of some feature of the icon. For treatment icons, for example, an image of the treatment being applied may be shown.

Using the toolbar 56, a user can draw the floor plan, and if multiple floors are needed, the user can select an additional floor and generate subsequent new blank grids.

To start the property/structure evaluation, the user can draw the floor plan on the grid using the tools. Alternatively, the user can import a file from the data base, such as a jpg file which can be made partially transparent, such as 25%, 50%, 75% transparent or any amount in between, so that the grid lines and icons will be visible through the transparency.

Alternatively, the non vector (i.e. image only file) can be converted by known means to vector file so that its lines with “snap to” the grid and additional lines and shapes can be concatenated thereto. Likewise photos may be used.

One the basic floor plan(s) have been drawn, the tools are used to post other artifacts of the structure and environment there around. If there are other levels to the structure, the grid which has already been drawn for one level can be duplicated onto other levels and then this copied grid can be further amended/modified.

Icon type and their count and location may be stored in the data base so that that information can be used for generating of a report.

For example, an icon for a bait station (see FIG. 4) can be linked to a price and the count of base stations can be used in tallying up the cost of placement.

In FIG. 4 there are also icons for pest issues which have been observed by the evaluator, who will place an icon proximate the sighting. To further evidence an issue, such as a wall crack (icon: visible damage), the user can photograph the issue from a camera and/or tablet camera. The image can be moved to the database and then when a camera icon is placed on the grid, it can be linked to the appropriate photo by opening the photo data file and tagging the appropriate file.

To assist in knowing where the direction of the camera was pointed when the photo was taken, the icon may include a pointer/arrow/camera lens and the icon can be rotated/oriented to point in the direction where the photo was taken. This is particularly important when it is not clear in which direction the photo was taken, such as in a corner or ceiling shot. The photo icon would include a short arrow/pointer extending therefrom to indicate the direction of the shoot.

Once the grid has been fully populated, a report can be generated from preexisting forms, text and fields which are populated from the data collected. Some icons, such as those which the pest control evaluator would install, will be associated with pricing and where the report includes a file for that icon the tally of such icons on the screen is tallied and associated with the price data to produce a line-item cost for that icon installation. Then a total cost can be tallied including other costs entered into the report.

If the customer/user/evaluator then wishes to increase/decrease/alter the number of installations (icons), the amount is adjusted on the report and price is recalculated.

To keep the report and grid map in agreement (synchronized), if icons are added in the report, then can appear on the grid. Because the report will not inherently know where the icons should be placed on the grid, they can be placed in a designated holding area (bull pen) and made to flash, vibrate, change color, or have some other indicia until they are dragged into the proper location desired, whereupon the indicia will terminate.

If the count of icons is decreased, to keep the grid map synchronized, all of that type of icons which are to be decreased, can be made to display a form of indicia which will make them recognizable, such as flashing, vibrating, shimmering, changing color or other available indicia. Then the user can review the grid map and delete selected icons with indicia until the icons lose their indicia, meaning the reduction in could have been met and the map and report are in sync.

It is possible that the synchronization can also be achieved by having a pop-up image of the grid map appear adjacent the report and the icons can be moved, removed, placed immediately in the report mode without the user having to switch back to the grid.

The evaluator may also want to present to the customer, a series of slides, photos, company information, etc., such as in connection with the report.

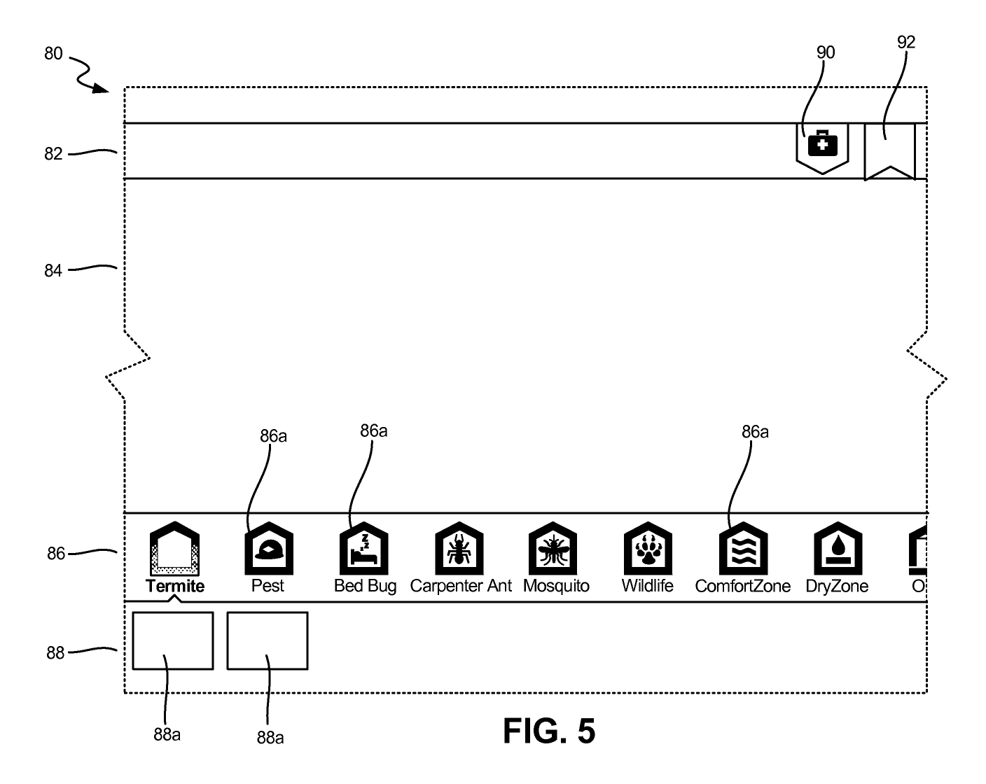

To do this, a present mode is initiated such as in FIG. 5 with display pane 80 has an upper band 82, mid-section 84 for presentations, a first tile/scroll bar 86 and a second space /tile/scroll bar 88 therebelow. The arrangement of these regions can be other than shown, such as vertical or in different positions.

In one region is found a “briefcase” icon or tab 90 and a book mark icon/tab 92 which perform functions and later explained.

The display area 84 provides a larger screen pane area for videos, PowerPoint® presentations and any other desired display. Band 86 includes a plurality of icons 86a which are preferably representation of programs, images, display elements which, when activated, run in window 84.

When running, the customer/user may wish to review certain slides from a particular presentation 86a. By clicking the book mark 92 on the currently displayed image in region 84, a thumbnail 88a will appear in field 88 in a sequence of thumbnails. These images are then stored in a database for later retrieval and possible export to a report.

When a customer/user views several presentations 86a but wishes to save certain images from variety of images from different programs. When a program is displaying an image in area 84, the user can activate briefcase tab 90 and a copy of that image will be placed in tray 88 as icon 88a. The user can switch to any program 86a and tag a sequence of images which will then be placed in try 88.

At any time, the user can press export and create a report or file of the sequence of images.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A graphical user interface computer program for building a portfolio of user selected image screens and creating a data file output of images, running on a computer having memory, a microprocessor, data storage and display, comprising:
a display pane operable to display a visible set of data records, the visible set of data records including data records from a selected set of data records from a data store;
a first portion of the display configured to display sequential screens of a running program;
a collection icon appearing in the display pane, said icon linked to the running program for tagging screen images appearing thereon:
a first brief case depository region on the display pane, the region configured to receive thumbnail images of screens tagged by the user when said collection icon is activated, thereby copying a thumbnail screen image of an image appearing in the first portion of the display screen and pasting said thumbnail image sequentially into said depository region;
a software routine for retrieving each of the tagged images, then retrieving the corresponding full image to which the thumbnail pertains and in concatenating the full images into a data file corresponding to a sequence of selected images and creating a computer file of such selected images for later viewing.

2. The interface according to claim 1 further including a scroll bar of images appearing display pane said scroll bar displaying a plurality of icons corresponding to available programs, whereby the user can select a program from said scroll bar, tag images from said program, select an alternate program, tag images from said alternate program and build a data file of images from multiple program.

3. The interface of claim 2 wherein said scroll bar is located between said first display portion and said depository region.

4. (canceled)

5. (canceled)

6. A graphical user interface computer program for assessing a physical structure for insect and pest control of the structure and generating a report therefor, comprising:
a display screen pane, connected to a computer processor, memory and data storage;
a graphical interface including a portion of the display pane having a grid wallpaper background;
a graphical interface including drawing tools for drawing physical structure representations on said grid;
a portion of said pane including a bar including a plurality of icons, said icons being linked to a data base and being positionable on the region of the pane having said grid;
a register for tallying the number of at least some icons which have been positioned on said grid;
a report generator for preparing a displayable report , said report generator being linked to said data base of tallied icons and in including at least some of said tallies into said report;
so that when a representation of a physical structure has been drawn on the grid, and populated with icons, a report is generated with a tally of icons included in the report.

7. The interface of claim 6 further including a bi-directional link between said report writer and said grid, so that increasing the tally of icons on the report, generates an increase in the number of icons on the grid.

8. The interface of claim 6 wherein said increased number of icons on the grid are placed in a confined area for later repositioning by the user.

9. The interface of claim 6 wherein said increase number of icons on the grid include an indicia to enhance a user's ability to find them on the grid.

10. The interface of claim 9 wherein said indicia is selected from the group of: flashing, changing color, vibrating, shimmering.

11. The interface of claim 6 further including a bi-directional link between said report writer and said grid, so that decreasing the tally of icons on the report, generates an indicia in the icons on the grid, so that the user can identify which icons must be deleted for conform to the tally in the report.

12. The interface of claim 11 wherein the indicia is applied to every icon of a type being decreased, and wherein the indicia is terminated when, on user deletion of icons on said display screen the tally of icons on screen has been reduced to the decreased tally.

13. The interface of claim 6 further including a bi-directional link between said report writer and said grid, so that decreasing the tally of icons on the report, generates a flashing indicia in the icons on the grid, so that the user can identify which icons must be deleted for conform to the tally in the report.

14. The interface of claim 6 further including a bi-directional link between said report writer and said grid, so that decreasing the tally of icons on the report, generates an indicia in the icons on the grid, in a specific location on the grids, so that the user can identify where such additional icons must be located on the grid to conform to the tally in the report.

15. (canceled)

16. (canceled)

17. (canceled)

18. A handheld computing device comprising:
a display screen;
an input device for operating the computing device and entering user responses;
a processor for executing programming that provides a user interface to a graphing software application wherein the user interface further comprises:
a display area on the display screen;
a graph paper area inside the display area,
an input from an input device which allows the user to manually enter data points on the graph paper area, and
wherein the manually entered data points are linked to a report, so that if data points tallied on the report are user altered, data points on the graph paper are likewise altered in quantity to maintain data synchronization between the graph paper and report.
